(19) United States
(12) Patent Application Publication
(10) Pub. No.: US 2021/0035143 A1
(43) Pub. Date: Feb. 4, 2021

(54) APPLICATION SALES MANAGEMENT SERVER SYSTEM, APPLICATION SALES MANAGEMENT SYSTEM, MANAGEMENT CONTROLLER, AND DISTRIBUTION CONTROLLER

(71) Applicant: FANUC CORPORATION, Minamitsuru-gun (JP)

(72) Inventors: Masaru ODA, Yamanashi (JP); Katsuyuki YAMANAKA, Yamanashi (JP); Robert PEIME, Yamanashi (JP)

(21) Appl. No.: 16/915,182

(22) Filed: Jun. 29, 2020

(30) Foreign Application Priority Data
Jul. 30, 2019 (JP) 2019-139395

(51) Int. Cl. G06Q 30/02; G06Q 20/32; G06Q 30/06

(52) U.S. Cl. CPC G06Q 30/0222; G06Q 30/0633; G06Q 20/3223

(57) ABSTRACT

A sales management server system is for management of online store sale of an application to run at an edge server connected to one or more edge devices. The sales management server system includes an app database storing the application, a management controller, and a distribution controller. The distribution controller includes: a purchase request transmitting unit that transmits purchase request information to a communicably connected developer terminal about the application for which a purchase request has been given via a communicably connected user terminal; and a result transmitting unit that transmits distribution authorization. information to the user terminal if availability information received from the developer terminal responsive to the purchase request includes an indication of being purchasable. The distribution controller includes an application distribution unit that distributes the application corresponding to the distribution authorization information in distribution request information transmitted from the user terminal to the specified edge server.

This application is based on and claims the benefit of priority from Japanese Patent Application No. 2019-139395, filed on 30 Jul. 2019, the content of which is incorporated. herein by reference.

### BACKGROUND OF THE INVENTION

### Field of the Invention

The present invention relates to an application sales management server system, an application sales management system, a management controller, and a distribution controller.

### Related Art

In the field of a manufacturing apparatus including a CNC machine tool, an industrial apparatus, an industrial robot, and the like for online store sale (also called “store sale”) of server application software having various functions or purposes targeted for a manufacturing site (also simply called “application” or “app”), an electronic commerce (EC) site (also called “app store”) has been provided in recent years to users. At such sites, applications developed by various application developers are subjected to predetermined examination, and then made available for sale on application stores. The applications made available are purchased by users. Then, these applications are installed on edge servers placed at manufacturing sites and used. As a specific example, on a manufacturing site such as a plant, data indicating a working state of a manufacturing apparatus, data indicating a production. state of the manufacturing apparatus, data indicating a quality state of a product manufactured by the manufacturing apparatus, data indicating an operation state of the manufacturing apparatus, and the like can be collected and utilized using an application on an edge server.

As an example, there is a known application sales management server system that manages selling of applications operated by an edge server communicably connected via the communication unit to one or more edge devices (patent document 1, for example). This system includes a communication. unit, a control unit, and a storage unit. The system is communicably connected to a user terminal of an intermediary dealer that relays selling of applications and a user terminal of an end user to use the edge device and the edge server. The control unit includes: distribution authorization information issuing means that issues distribution authorization information for associating the application and a license of the application on the basis of a request to purchase the application from the user terminal of the intermediary dealer to the application sales management server system; and application distribution means that distributes the application associated with the distribution authorization information and the license together to the edge server in response to receipt of the distribution authorization information from the user terminal of the end user. The license of the application includes number information about the number of connectable edge devices defined by one license. The number of the edge devices to be connected to the edge server is controlled on the basis of the license using the application.

The content of an application for sale at such an app store is grasped by a developer of the application. On the other hand, an operator of the app store cannot grasp the content of the application unless the content is disclosed by the developer of the application. However, the operator of the app store is to be unduly responsible for an application to be sold in terms of function, reliability, etc.

Patent Document 1: Japanese Unexamined Patent Application, Publication No. 2019-21090

### SUMMARY OF THE INVENTION

Hence, a mechanism of making an appropriate side take responsibility for an application in terms of function, reliability, etc. has been desired.

(1) According to one aspect of this disclosure, an application sales management server system is for management of online store sale of an application to run at an edge server communicably connected to one or more edge devices. The application sales management. server system includes: an app database storing the application generated by a developer to be registered for online store sale; a management controller that manages online store sale for making the application available for purchase stored in the app database and registered for online store sale; and a distribution controller that distributes the application to the edge server. The application sales management server system is communicably connected via a communication network to a user terminal of a user to use the edge device and the edge server and to a developer terminal of the developer. The management controller includes: a purchase request transmitting unit that transmits purchase request information to the developer terminal of the developer of the application about the application for which a purchase request has been given from the user via the user terminal; and a result transmitting unit. If availability information received from the developer terminal responsive to the purchase request includes an indication of being purchasable, the result transmitting unit transmits purchase authorization information to the user terminal including distribution authorization information for making correlation with the application. If the availability information responsive to the purchase request indicates an indication of not being purchasable, the result transmitting unit transmits the indication of not being purchasable to the user terminal. The distribution controller includes an application distribution unit that distributes the application corresponding to the distribution authorization information to the edge server in response to receipt of distribution request information including the distribution authorization information transmitted from the user terminal.

(2) According to one aspect of this disclosure, a management controller is provided in an application sales management server system for management of online store sale of an application to run at an edge server communicably connected to one or more edge devices. The management controller manages online store sale for making the application available for purchase stored in an app database storing the application generated by a developer and registered for online store sale. The management controller is communicable connected via a communication network to a user terminal of a user to use the edge device and the edge server and to a developer terminal of the developer. The management controller includes: a purchase request transmitting unit that transmits purchase request information to the developer terminal of the developer of the application about the application for which a purchase request has been given from the user via the user terminal; and a result transmitting unit. If availability information received from the developer terminal responsive to the purchase request includes an indication of being purchasable, the result transmitting unit transmits purchase authorization information to the user terminal including distribution authorization information for making correlation with the application. If the availability information responsive to the purchase request includes an indication of not being purchasable, the result transmitting unit transmits the indication of not being purchasable to the user terminal.

(3) According to one aspect of this disclosure, a distribution controller is provided in an application sales management server system for management of online store sale of an application to run at an edge server communicably connected to one or more edge devices. The distribution controller distributes the application generated by a developer and stored in an app database to the edge server. The distribution controller is communicably connected via a communication network to a user terminal of a user to use the edge device and the edge server and to a developer terminal of the developer. The distribution controller includes an application distribution unit. In response to receipt of distribution request information from the user terminal including distribution authorization information for making correlation with the application and included in purchase authorization information transmitted to the user terminal from a management controller that manages online store sale for making the application available for purchase stored in the app database and registered for online store sale, the application distribution unit distributes the application corresponding to the distribution authorization information to the edge server.

The application sales management server system, the application sales management system, the management controller, and the distribution controller provided by the aspect can be configured to make an appropriate side take responsibility for an application in terms of function, reliability, etc.

### BRIEF DESCRIPTION OF THE DRAWINGS

FIG. 1 is a schematic view showing a basic configuration of an application sales management system according to an embodiment;

FIG. 2 is a functional block diagram of a management server in a sales management server system according to the embodiment;

FIG. 3 shows an example of a storage unit of the management server in the sales management server system according to the embodiment;

FIG. 4 shows an example of a browsing screen displayed on a user terminal according to the embodiment;

FIG. 5A is a functional block diagram of a distribution server in the sales management server system according to the embodiment;

FIG. 5B shows an example of a storage unit of the distribution server in the sales management server system according to the embodiment;

FIG. 6 shows an example of an app DB in the sales management server system according to the embodiment;

FIG. 7 is a flowchart showing a browsing information providing process in the management server according to the embodiment;

FIG. 8 is a flowchart showing a purchase requesting process in the management server according to the embodiment;

FIG. 9 is a flowchart showing a sales authorizing process in the sales management server system according to the embodiment;

FIG. 10 is a flowchart showing an application distributing process in the distribution server according to the embodiment; and

FIG. 11 is a schematic view showing a basic configuration of an application sales management system according to a modified embodiment.

### DETAILED DESCRIPTION OF THE INVENTION

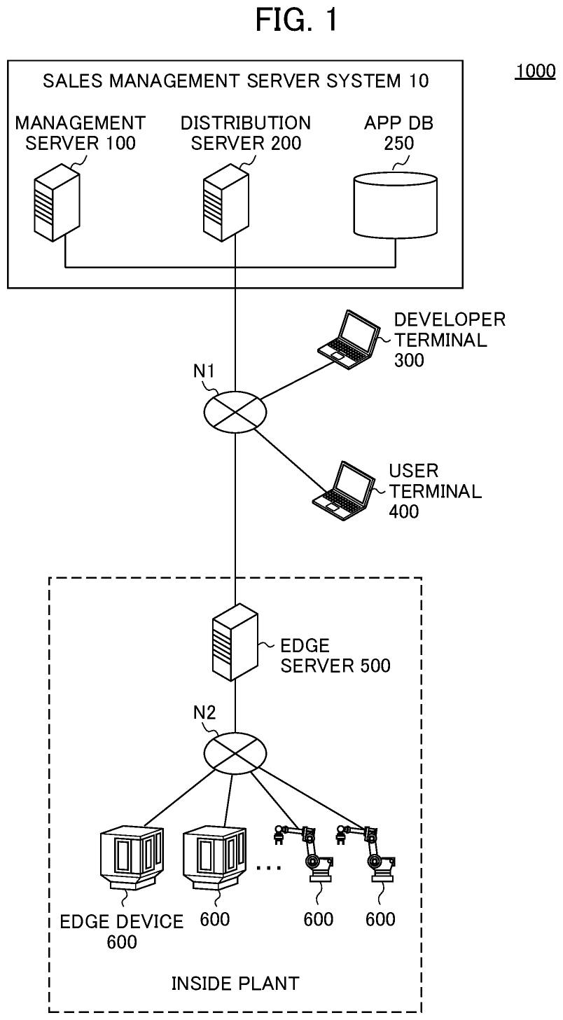

The configuration of an application sales management system 1000 according to an embodiment will be described. The application sales management system 1000 shown in FIG. 1 includes an application sales management server system 10 (hereinafter also called “sales management server system 10”), a developer terminal 300, a user terminal 400, an edge server 500, and an edge device 600. The sales management server system 10, the developer terminal 300, the user terminal 400, and the edge server 500 are communicably connected via a network N1. The network N1 is the Internet, a virtual private network (VPN) , a public telephone network, or the like, for example. A specific communication method of the network N1 and whether the network N1 is a cable connection or a wireless connection are not particularly limited.

As shown in FIG. 1, for example, the sales management server system 10 is configured using a management server 100 as a management controller, a distribution. server 200 as a distribution controller, and an app DB (database) 250. The sales management server system 10 may be configured using one server having the functions of the management server 100, the distribution server 200, and the app DB 250. Alternatively, the sales management server system 10 may be configured using two servers including one server having the functions of the distribution server 200 and the app DB 250, and the management server 100. In another case, the functions of the management server 100, the distribution server 200, and the app DB 250 may be configured using a plurality of servers, and processes may be distributed to corresponding servers. In another case, the sales management server system 10 may be configured in such a manner that the management server 100 is communicably connected to the edge server 500, etc. via the network N1, and the distribution server 200 is not connected to the network N1 but is to communicate with the edge server 500, etc. via the management server 100, for example. Still further, the edge device 600 is preferably configured in such a manner as to be communicably connectable to the management server 100 and not to be connected communicably to the distribution server 200. The management server 100, the distribution server 200, and the app DB 250 are not always required to be server devices physically independent of each other but may be independent virtual servers in a cloud, for example.

The developer terminal 300 and the user terminal 400 are personal computers (PCs), for example. The developer terminal 300 and the user terminal 400 are communicably connected to the sales management server system 10. The developer terminal 300 is a terminal of an application developer (also called “app developer”) , and is used in registering an application generated by the app developer with the sales management server system 10, for example. The application transmitted from the developer terminal 300 is examined at the sales management server system 10, and then registered with the app DB 250, for example. If there is a request from a user to purchase the application generated by the app developer, the developer terminal 300 transmits availability information for judging whether selling of the application to the user is authorized.

The user terminal 400 is a terminal used by an end user, for example, who wishes to purchase a server application to run at the edge server 500. In FIG. 1, the user terminal 400 is illustrated as a terminal provided outside a plant facility. Alternatively, the user terminal 400 may be provided inside a plant facility. A user can access the sales management server system 10 via the user terminal 400 and browse the content of an application available for purchase by the user. Moreover, the user can request purchase of the application via the user terminal 400. Only if the user satisfies a preset condition (has a qualification, for example) , the user can be given a user ID (identification) for accessing the sales management server system 10.

The edge server 500 is a server that executes an application purchased from the sales management server system 10 and performs predetermined information processing relating to the purchased application. An example of a server application to run at the edge server 500 is a server application that collects data indicating a working state of the edge device 600 described later, data indicating a production state, data indicating a quality state of a product, data indicating an operation state, etc. However, this is not the only server application.

The edge device 600 means a manufacturing apparatus including a CNC machine tool, an industrial apparatus, an industrial robot, and the like, provided in a manufacturing site such as a plant and an apparatus associated with the manufacturing apparatus such as an image sensor or a programmable logic controller (PLC) , for example. One or more edge devices 600 form a line or a cell of a plant, for example. From a different viewpoint, the edge device 600 can also be said to be a device having a function as a client of the edge server 500. The edge server 500 and. one or more edge device 600 are placed in a plant facility of a user, for example, and communicably connected via a network N2 such as a local area network (LAN).

The sales management server system 10 is an online store system for assisting in implementation of a sales managing process for a user who wishes to purchase a server application to run at the edge server 500. As will be described later, when a user requests the management server 100 to purchase a desired server application via the user terminal 400 and if the user is authorized by an app developer, for example, the user becomes capable of acquiring a serial number (license key) relating to this server application from the management server 100. By doing so, the user becomes capable of making the distribution server 200 distribute (install) this server application onto the edge server 500 on the basis of the acquired serial number. The serial number (license key) is identification information given uniquely and distribution authorization information to be given if distribution of this server application is authorized.

Each of the servers in the sales management server system 10 will be described next.

### [Configuration of Management Server 100]

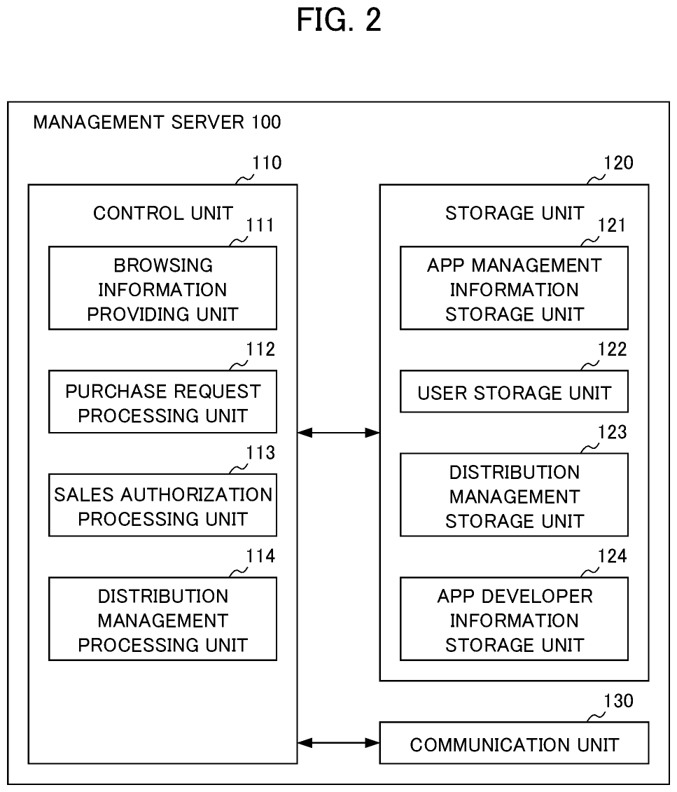

The management server 100 shown in FIG. 2 includes a control unit 110, a storage unit 120, and a communication unit 130. The control unit 110 may be a CPU, and controls the management server 100 in an integrated manner by executing various programs stored in the storage unit 120. The communication unit 130 is a communication control device that transmits and receives data to and from an external device (for example, developer terminal 300, user terminal 400, and edge server 500, etc.) via the network N1.

In the management server 100, the control unit 110 includes a browsing information providing unit 111, a purchase request processing unit 112, a sales authorization processing unit 113, and a distribution management processing unit 114 as functional units based on the programs stored in the storage unit 120. In addition to the programs to be executed by the control unit 110, the storage unit 120 includes an app management information storage unit 121, a user storage unit 122, a distribution management storage unit 123, and an app developer information storage unit 124. The storage unit 120 will be described first before description of each functional unit of the control unit 110.

### <App Management Information Storage Unit 121>

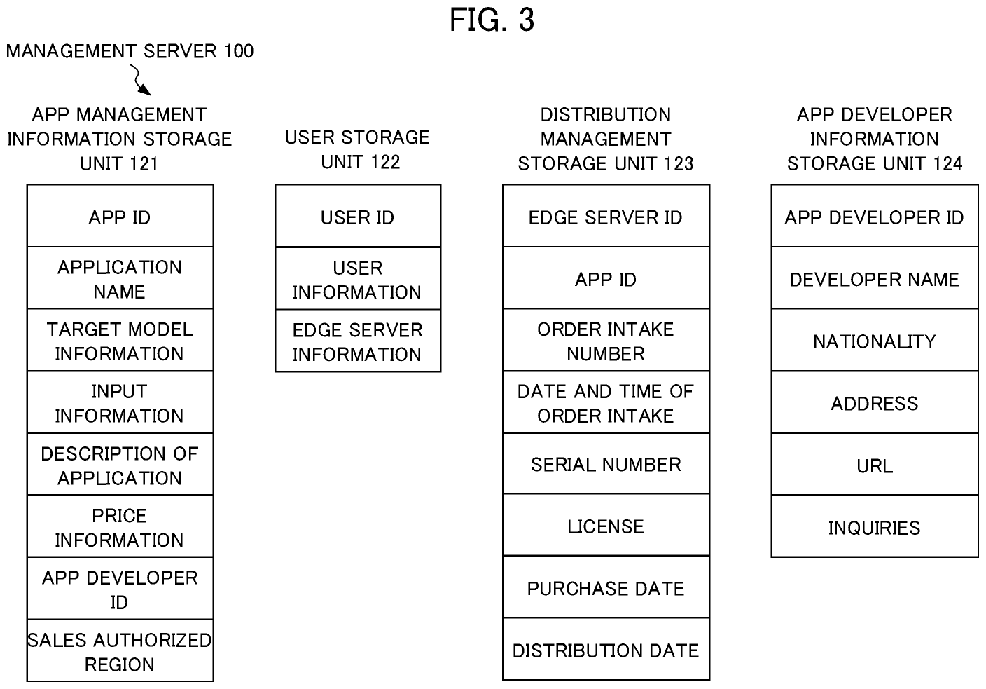

The app management information storage unit 121 is a storage area that stores management information (metadata) about a purchasable app in the sales management. server system 10. In the embodiment, the app management information storage unit 121 does not store an application program itself but the application program is stored in the app DB 250 described later. As shown in FIG. 3, as an example, the app management information storage unit 121 can store the following data in correlation with an app ID: an application. name (and/or product. name), target model information, input information, an. application description, price information, an app developer ID, a sales authorized region, etc. Data stored in the app management information storage unit 121 is not limited to these pieces of data. Some of the data items shown as examples and a different data item may be stored.

The app ID is identification information for identifying an application. The target model information is model information about the edge device 600 which is an input/output target of the application and is a model name of a CNC machine tool, an industrial apparatus, an industrial robot, or the like, for example. The input information is edge device information including input data information or the like input from the edge device 600. The application description includes a description of a license, for example, as a description of the specifications of an application. The description of a license includes information about designation. of the edge device 600 indicating whether the edge device 600 that uses the application is designated and information about the number of edge devices 600 to be used concurrently indicating whether it is necessary to purchase a number of edge devices 600 to be used concurrently or there is no limit in the number of edge devices 600 to be used concurrently, for example. With regard to the use of an application, the description also includes a description of the presence of absence of renewal of a contract. The price information is information about a sales price of an application. The app developer ID is identification information for identifying an app developer of the application. The sales authorized region is information about a region (country name, for example) where selling of an application designated by an app developer is authorized.

### <User Storage Unit 122>

The user storage unit 122 is a storage area that stores information about a user where the edge server 500 communicably connected to the sales management server system 10 is placed. The edge server 500 is placed on condition that the user satisfies a preset condition (has a qualification, for example). The user where the edge server 500 is placed is a user authorized to access the sales management server system 10. Namely, the user is given a user ID for accessing the sales management server system 10. The user may include a specialized dealer such as a system integrator or a machine tool manufacturer in addition to an end user.

As shown in FIG. 3, the user storage unit 122 stores user information, edge server information, etc, in correlation with a user ID. The user ID is identification information for identifying a user. As an example, the user information may include information about the user such as a user name, a representative name, an address including a country name (region), a telephone number, a mail address, URL, a user level, and right for authorizing purchase. The user level is a level determined by an attribute of the user for classifying the user as an end user, a specialized dealer including a vendor, a system integrator, and the like, for example, or a specialized dealer including a machine tool manufacturer, a facility manufacturer, and the like, for example. The right for authorizing purchase is information for determining whether the user identified using the user ID (specialized dealer or end user) is authorized to request the sales management server system 10 to purchase an application. The user information is not limited to these pieces of information. The user information may include some of the data items shown as examples and a different data item. These pieces of user information may be generated when the edge server is placed for the first time for the user, for example, and then updated on each occasion of a situation relating to change in the user information (addition of an edge server, for example).

The edge server information is information about the edge server 500 placed in a plant or a manufacturing site associated with a user particularly if the user is an end user, and is information for specifying the edge server 500 which is an application distribution destination. As an example, the edge server information may include an edge server ID for identifying the edge server 500, a location of placement of the edge server 500, address information on a communication network such as an IP address of the edge server 500, etc. If one or more edge servers 500 are provided in a plant or the like associated with the user, for example, the edge server ID becomes necessary for identifying each of the edge servers 500.

Moreover, the edge server information may include information about the edge device 600 serving as a client candidate of the edge server 500, which is likely to input and output information with respect to the edge server 500. The information about the edge device 600 may include an edge device ID for identifying the edge device 600, a model name of the edge device 600, an address (for example, an IP address) of the edge device 600 on a communication network, etc. The edge server information is not limited to these pieces of data. The edge server information may include some of the data items shown as examples and a different data item.

### <Distribution Management Storage Unit 123>

The distribution management storage unit 123 is a storage area that stores distribution. management information about an. application distributed to an arbitrary edge server 500 in correlation with a distribution destination edge server 500. The distribution management storage unit 123 stores information about the distributed application and the distribution destination edge server 500 in association with each other. As shown in FIG. 3, the distribution management storage unit 123 stores distribution management information in which an edge server ID for identifying the distribution destination edge server 500 and an app ID for identifying the distributed application are used as retrieval keys, and data including an edge server ID of the distribution destination edge server 500 and an app ID of the distributed application is used as a retrieval key (composite key), for example. In addition to the foregoing retrieval keys, the distribution management information stores an order intake number, date and time of order intake, a serial number, license, a purchase date (date of acquisition of license), and a distribution date, for example. The distribution management information may store various types of data for managing the distributed application as other items. Such other items include a next contract scheduled date defined if a present license contract is to be maintained continuously, a next contract renewal notification date on which a confirmation notification is transmitted, a next contract renewal notification destination address to be used for giving the notification, and a notification completion flag indicating whether the confirmation is given, for example. The data in the distribution management information is not limited to these pieces of data. Some of the data items shown as examples and a different data item may be stored.

The order intake number is a number for managing a processing situation (processing state) from acceptance of a request to purchase the app from a user to distribution of this app, for example. The date and time of order intake is date and time when the request to purchase the app is received from the user. The serial number is a number given uniquely to the purchased application. The license is information about the edge device 600 which is authorized to perform connection and/or input/output to the application in relation to a license of the application distributed. to the edge server 500, for example. The purchase date is a date on which a serial number of the application is notified of (namely, a date of license acquisition by the user). The distribution date is a date on which the application is distributed to the edge server 500. As a result, it becomes possible to easily retrieve information about to which edge server 500 each application has been distributed, when a purchase request for each application has been received, and when each application is distributed, etc.

### <App Developer Information Storage Unit 124>

The app developer information storage unit 124 stores app developer information including the following in correlation with an app developer ID: the name, nationality, address, URL, inquiry mail address, etc. of an app developer. The storage unit 120 may additionally store order intake management information for managing a processing situation about a request to purchase an app from a user from receipt of the request to purchase the app. The order intake management information may include the following, for example, in correlation with an order intake number: date and time of order intake, an app ID for which an order has been made, a user ID of the user having ordered the app, etc. If distribution of the application is authorized in response to the order intake, corresponding information may be stored into the distribution management storage unit 123. If distribution of the application is not authorized in response to the order intake, this information may be stored as it is as an order intake history into the storage unit 120, or may be deleted.

Each functional unit of the control unit 110 of the management server 100 will be described next. As shown in FIG. 2, the management server 100 includes the browsing information providing unit 111, the purchase request processing unit 112 functioning as a purchase request transmitting unit and a result transmitting unit, the sales authorization processing unit 113 functioning as an issuing unit and a checking information transmitting unit, and the distribution management processing unit 114 functioning as a distribution request transmitting unit.

### <Browsing Information Providing Unit 111>

The browsing information providing unit 111 provides application information that a user can browse in response to a browsing request for application information from a user received from the user terminal 400. The browsing information providing unit 111 refers to the app management information storage unit 121 and the user storage unit 122, extracts application information about an application that can be provided to a logged-in user, and provides the extracted application information to the user terminal 400.

The browsing information providing unit 111 generates a browsing screen 160 including the extracted application information, and provides the browsing screen 160 to the user terminal 400. If a plurality of applications is extracted, the browsing information providing unit 111 may generate an application list screen and transmit the application list screen to the user terminal 400. When a selection associated with one application is received from the user terminal 400, the browsing information providing unit 111 may extract information about the selected application from the app management information storage unit 121, and generate the browsing screen 160.

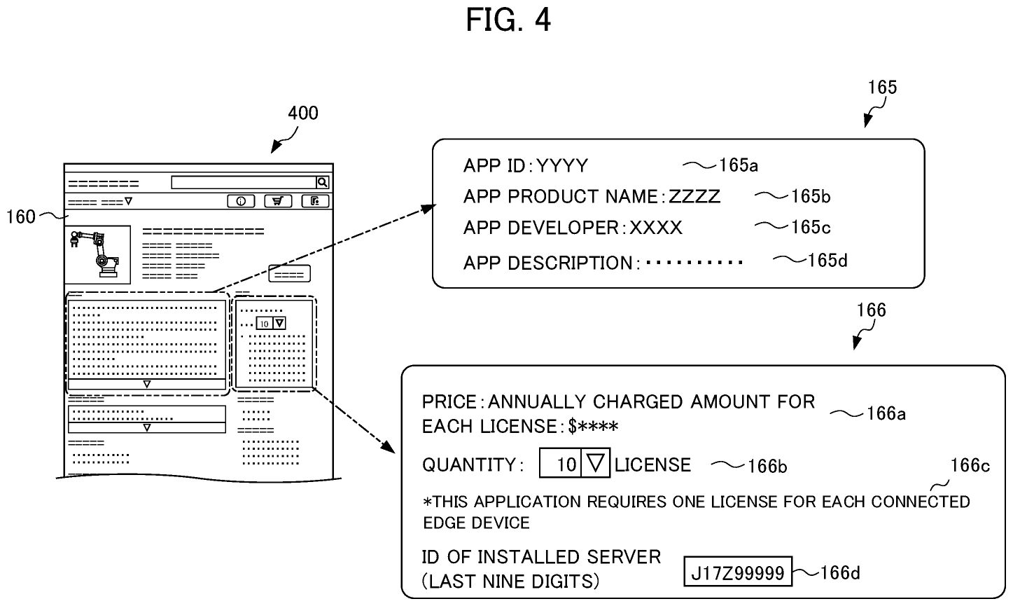

The browsing screen 160 shown in FIG. 4 includes application description 165 and description 166 of an application license, for example. The application description 165 includes an app ID 165a, an app product name 165b, an app developer 165c, and description 165d of the content of an application, for example. The description 166 of a license includes price information 166a, license quantity 166b, license description information 166c, and edge server ID indicating portion 166d, for example. As the browsing screen 160 includes the description 166 of a license, each user can check information about a necessary license.

The browsing screen 160 may further function as a purchase requesting screen. In this case, to enable making of a purchase request, the browsing screen 160 may include a purchase button, for example, to be displayed for allowing a user having right for authorizing purchase to make a purchase request. For making the purchase request, the user may be caused to input purpose of use of an app. Further, if an application as a purchase candidate is selected by a user when the user is browsing the application, for example, the browsing information providing unit 111 may store an ID of the selected application, for example, into a purchase candidate storage unit (what is called “cart”) (not shown) for temporary storage. Then, in response to designation by the user, the browsing information providing unit 111 may display the browsing screen 160 as a purchase requesting screen on which a purchase button for purchasing the application ID (product name) stored in the purchase candidate storage unit (cart) (not shown) is displayed for each application or such purchase buttons are displayed collectively.

### <Purchase Request Processing Unit 112>

In response to receipt of a request to purchase an application from the user terminal 400, the purchase request processing unit 112 shown in FIG. 2 transmits purchase request information to the developer terminal 300 of an app developer having generated. the application. The purchase request information includes the name and the address including a nationality of the user specified from a user ID, and an application name. The purchase request information may further include a license quantity, purpose of use of the app, etc.

The purchase request processing unit 112 gives an order intake number to each app having requested to be purchased, for example, and. stores order intake management information including date and time of order intake, an ID of an app for which an order has been made, a user ID, etc. into the storage unit 120. Payment of a fee of the app requested to be purchased is to be checked by a publicly known method (on credit or electronic withdrawal, for example) before downloading of the app.

As a result of the process performed by the purchase request processing unit 112, an app developer having the developer terminal 300 at which the purchase request information has been received refers to information about the user included in the purchase request information, and judges whether to authorize selling of the application to the user. Then, the developer terminal 300 transmits availability information responsive to the purchase request to the management. server 100 showing a result of the judgment about selling made by the app developer.

The purchase request processing unit 112 receives the availability information responsive to the purchase request from the developer terminal 300 if the availability information includes an indication of being purchasable, a process described later is performed by the sales authorization processing unit 113. If the availability information includes an indication of not being purchasable, the purchase request processing unit 112 transmits the indication to the user terminal 400 notifying that purchase of the application responsive to the purchase request is not authorized. In this case, the purchase request processing unit 112 transmits an email (called “rejection mail”) , etc. for notifying that purchase of the app has been rejected and a purchase procedure will be finished to inquiries (mail address, for example) of the user having requested to purchase the app. By doing so, a process relating to this accepted order is finished.

### <Sales Authorization Processing Unit 113>

The sales authorization processing unit 113 performs a process if an indication of being purchasable responsive to a purchase request is included in availability information by the process performed by the purchase request processing unit 112. The sales authorization processing unit 113 generates a serial number (license key) of an application corresponding to purchase request information. Then, the sales authorization processing unit 113 transmits purchase authorization information including the generated serial number to the user terminal 400.

The purchase request processing unit 112 may transmit an email as the purchase authorization information including an ID and a password for logging in to an exclusive screen (not shown) for displaying the serial number of the application, for example, to a user who has requested. to purchase the application. By doing so, when the user displays the exclusive screen and then logs in to the exclusive screen using the ID and the password given in the email, the purchase request processing unit 112 may display the serial number on the exclusive screen. By doing so, even if an outsider fraudulently uses the user terminal 400 of a user having right for authorizing purchase, the serial number is left unknown to the outsider and the system can be operated in a mechanism with improved security.

Further, the sales authorization processing unit 113 transmits checking information including the generated serial number to the distribution server 200. In addition to the serial number, the checking information includes a user ID, an app ID, a license, an edge server ID of the edge server 500 as a distribution destination, and the address of the distribution destination, for example.

### <Distribution Management Processing Unit 114>

The distribution management processing unit 114 manages distribution management information about an application. The distribution management processing unit 114 receives the distribution management information from an app distribution processing unit 212 (described later), and stores distributed application information and a distribution destination edge server 500 in association. with each other. As described above, the distribution management processing unit 114 stores distribution management information into the distribution management storage unit 123 using an edge server ID for identifying the distribution destination edge server 500 and an app ID for identifying the distributed application as retrieval keys, and using data including the edge server ID of the distribution destination edge server 500 and the app ID of the distributed application as retrieval keys (composite key), for example.

For example, the distribution management processing unit 114 provides an administrator and the like of an operational administration company responsible for operational administration of the sales management server system 10 with a function of retrieving/checking the distribution management information stored in the distribution management storage unit 123 via an operational administration terminal (not shown). This makes it possible to easily retrieve information about to which edge server 500 each application has been distributed, when a contract renewal date comes for each application on the edge server 500, etc. This further facilitates retrieval of information about an application out of applications distributed to each edge server 500 for which a contract renewal date comes and information about when this contract renewal date comes, for example. Additionally, a confirmation notification about application contract renewal can be transmitted for each application and/or each edge server 500 to a next contract renewal notification destination address (user terminal 400 and/or email address, for example) on a next contract renewal notification date prior to a next contract renewal date.

### [Configuration of Distribution Server 200]

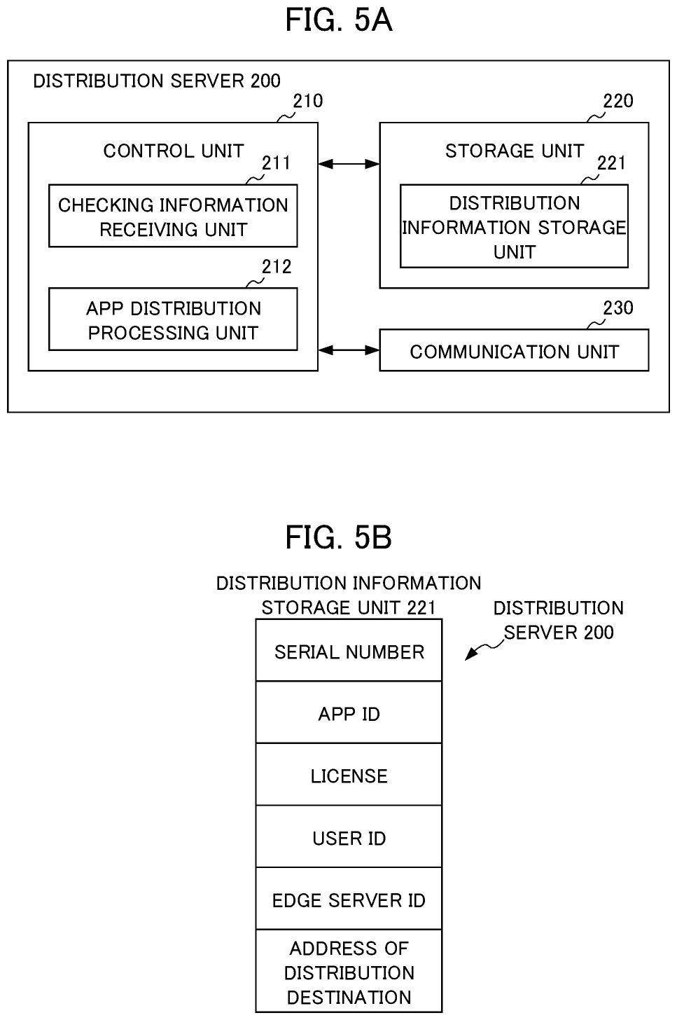

As shown in FIG. 5A, the distribution server 200 includes a control unit 210, a storage unit 220, and a communication. unit 230. The control unit 210 may be a CPU, and controls the distribution server 200 in an integrated manner by executing various programs stored in the storage unit 220. The communication unit 230 is a communication control device that transmits and receives data to and from an external device (for example, user terminal 400 and edge server 500, etc.) via a network. The control unit 210 includes a checking information receiving unit 211 and an app distribution processing unit 212 as functional units based on the programs stored in the storage unit 220. In addition to the programs to be executed by the control unit 210, the storage unit 220 includes a distribution information storage unit 221. The storage unit 220 will be described first before description of each functional unit of the control unit 210.

### <Distribution Information Storage Unit 221>

The distribution information storage unit 221 is a storage unit provided for distributing an app requested. to be purchased from a user and authorized to be purchased by an app developer. As shown in FIG. 5B, the distribution information storage unit 221 may include the following in correlation with a serial number (license key) of the app to be distributed: an app ID of the application to be distributed, a license, a user ID of the user having made the purchase request, an ID and an address on a communication network such as an IP address of distribution destination edge server 500, etc.

Each functional unit of the control unit 210 of the distribution server 200 will be described next.

### <Checking Information Receiving Unit 211>

The checking information receiving unit 211 receives checking information transmitted from the sales authorization. processing unit 113 of the management server 100. Then, the checking information. receiving unit 211 stores the received checking information into the distribution information storage unit 221.

### <App Distribution Processing Unit 212>

When a serial number (license key) and a request to distribute an application are received. together via the user terminal 400 from a user having purchased this app, the app distribution processing unit 212 refers to the distribution information storage unit 221 on the basis of the received. serial number. Then, the app distribution processing unit 212 specifies a record in the distribution information storage unit 221 including a matching serial number, checks an ID of the app to be distributed and a distribution destination edge server 500, and distributes this application from the app DB 250 to the distribution destination edge server 500. More specifically, on the basis of the serial number included in the application distribution request from the user received. via the user terminal 400, the app distribution processing unit 212 first specifies the application to be distributed, a license, and the edge server 500 to which the application is to be distributed. Then, the app distribution processing unit 212 distributes the application acquired from the app DB 250 to the specified edge server 500 on the basis of the license and the app ID correlated with the serial number. Here, the license is use authorization information about the edge device 600 serving as a client (that is, a connection and/or input/output target) of the application, for example. The license may be distributed to the edge server 500 in a state of being included in the application. The license may be distributed to the edge server 500 separately from the application.

By doing so, the user becomes capable of downloading the purchased application to the specified edge server 500. In this manner, the app distribution processing unit 212 specifies the application and the edge server 500 on the basis of the serial number included in the distribution request. Thus, only a specific user who can know the serial number is allowed to transmit a distribution request. That is, even if an outsider transmits a distribution request, an application is not to be distributed since the outsider does not know a serial number. The edge server 500 as the application distribution destination is specified. using a serial number. Thus, even if an outsider happens to know the serial number, distribution of the application to a server other than the specified edge server 500 is still prohibited.

The app distribution processing unit 212 generates distribution management information about the distributed. application in correlation with the distributed application information and the distribution destination edge server 500, and transfers the generated distribution management information to the management server 100 (distribution management processing unit 114). With data including the edge server ID of the distribution destination edge server 500 and the app ID of the distributed application used as retrieval keys (composite key), the distribution management information includes the product name, order intake number, serial number, license, purchase date, distribution date of the distributed application, for example. The control unit 210 may provide an administrator of the operational administration company, for example, with a function of retrieving/checking distribution data stored in the distribution information storage unit 221 via the operational administration terminal (not shown).

### [App DB 250]

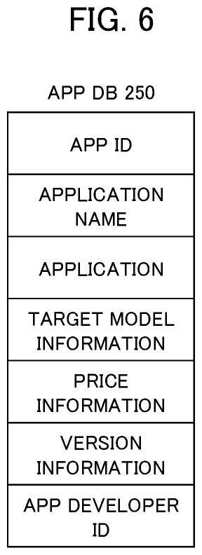

The app DB 250 is a database storing an application generated by a developer. As described above, an application transmitted from the developer terminal 300 and then subjected. to examination is registered with the app DB 250, for example. FIG. 6 shows an example of the app DB 250. As shown in FIG. 6, the app DB 250 stores an application body in correlation with an app ID. The app DB 250 may store the following registered items, if appropriate: the product name of an application, target model information, price information, the version number of the application, an app developer ID, etc.

A process flow in the sales management server system 10 will be described next.

### [Browsing Information Providing Process]

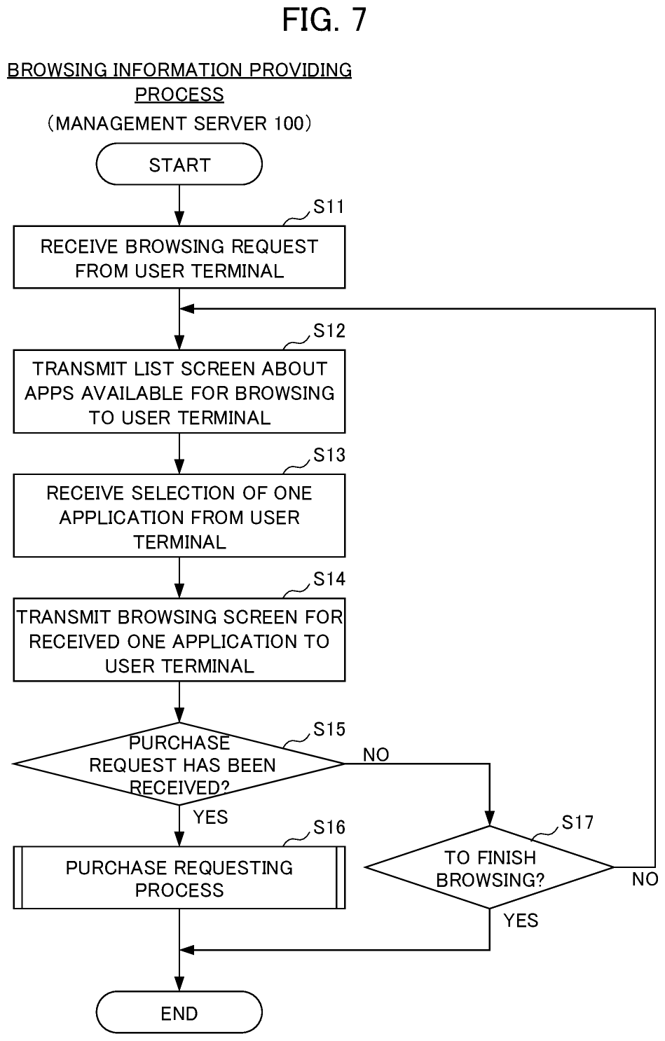

A process relating to browsing of an application will be described first on the basis of a flowchart in FIG. 7 showing a browsing information providing process in the management server 100. For browsing application information, each user operates the user terminal 400 to log in to the sales management server system 10. The user may use a publicly-known method for the login. For example, the user proceeds to user authentication using individual information about the user, an ID, or a password management file including a password, for example. Then, the user is confirmed to be an authorized user.

Next, the user selects application browsing from a menu screen not shown displayed on the user terminal 400. Then, in step S (in the following description, “step S” will simply be called “S”) 11, the control unit 110 (browsing information providing unit 111) receives a browsing request transmitted from the user terminal 400. In S12, the control unit 110 (browsing information providing unit 111) transmits a list screen containing applications available for browsing by the user to the user terminal 400.

In S13, the control unit 110 (browsing information providing unit 111) receives selection of one application from the user terminal 400 having details intended to be checked. In S14, the control unit 110 (browsing information providing unit 111) refers to the app management information storage unit 121 to provide the browsing screen 160 for application information about the one received application. The displayed browsing screen 160 can include price information about the one application, a purchase button, etc.

In S15, the control unit 110 judges whether a request to purchase the one application has been received from the user terminal 400. When the user selects the purchase button on the browsing screen, for example, the user terminal 400 transmits a request to purchase the one application. If the purchase request has been received (S15: YES), the control unit 110 transfers the process to S16. If the purchase request has not been received (S15: NO), the control unit 110 transfers the process to S17. In S16, the control unit 110 (purchase request processing unit 112) generates order intake management information on the basis of the received purchase request, stores the generated order intake management information temporarily into the storage unit 120, and. then performs a purchase requesting process described next. Then, the control unit 110 finishes the present process.

In S17, the control unit 110 judges whether to finish the browsing information providing process. If an instruction to finish browsing is given from the user terminal 400, for example, the control unit 110 judges that the browsing information providing process is to be finished. If selection to make a return to the list screen is made from the user terminal 400, for example, the control unit 110 judges that the browsing information providing process is not to be finished. If the browsing information providing process is to be finished (S17: YES), the control unit 110 finishes the present process if the browsing information providing process is not to be finished (S17: NO), the control unit 110 transfers the process to S12.

### [Purchase Requesting Process]

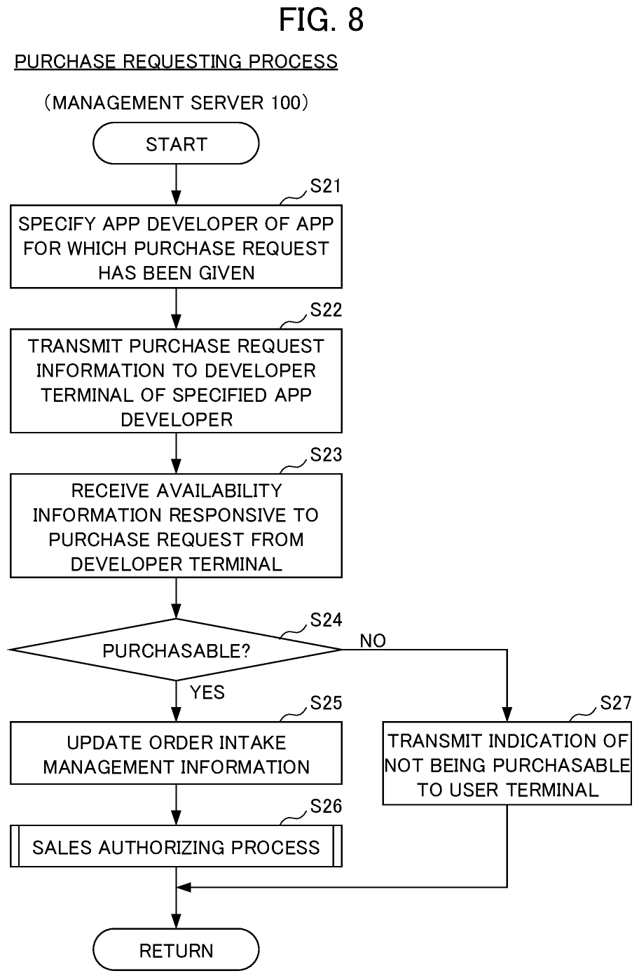

A process relating to an application purchase request will be described next on the basis of a flowchart in FIG. 8 showing a purchase requesting process in the management server 100. In S21, on the basis of a purchase request from a user, the control unit 110 (purchase request processing unit 112) of the management server 100 specifies an app developer of an app requested to be purchased by referring to the app management information storage unit 121 and the app developer information storage unit 124. In S22, the control unit 110 (purchase request processing unit 112) transmits purchase request information to the developer terminal 300 of the specified app developer. The purchase request information includes the name of the application, and further includes the name of the user and. the address of the user including a nationality. The control unit 110 may transmit the purchase request information to the developer terminal 300 via an email, for example.

As a result of this process, the purchase request information is transmitted to the developer terminal 300. Then, the app developer refers to the purchase request information to judge whether to sell the application to the user. During implementation of this purchase requesting process, the control unit 110 (purchase request processing unit 112) may transmit a notification to the user terminal 400 indicating a state waiting for confirmation by the app developer.

In S23, the control unit 110 (purchase request processing unit 112) receives availability information from the developer terminal 300 responsive to the purchase request. In S24, the control unit 110 (purchase request processing unit 112) judges whether the availability information received from the developer terminal 300 responsive to the purchase request includes an indication of being purchasable. If there is an indication. of being purchasable (S24: YES), the control unit 110 transfers the process to S25. If there is an indication of not being purchasable (S24: NO), the control unit 110 transfers the process to S27.

In S25, the control unit 110 (purchase request processing unit 112) updates order intake management information stored in. the storage unit 120. In S26, the control unit 110 (sales authorization processing unit 113) performs a sales authorizing process described later, and then finishes the present process. In S27, the control unit 110 (purchase request processing unit 112) transmits an indication of not being purchasable to the user terminal 400, and then finishes the present process. The control unit 110 may transmit an email (“rejection mail”) , etc., for indicating that purchase of the app has been rejected and a purchase procedure will be finished to inquiries (mail address, for example) of the user having requested to purchase the app. The management server 100 (purchase request processing unit 112) deletes the corresponding order intake management information from the storage unit 120, for example, and then finishes the process.

### [Sales Authorizing Process]

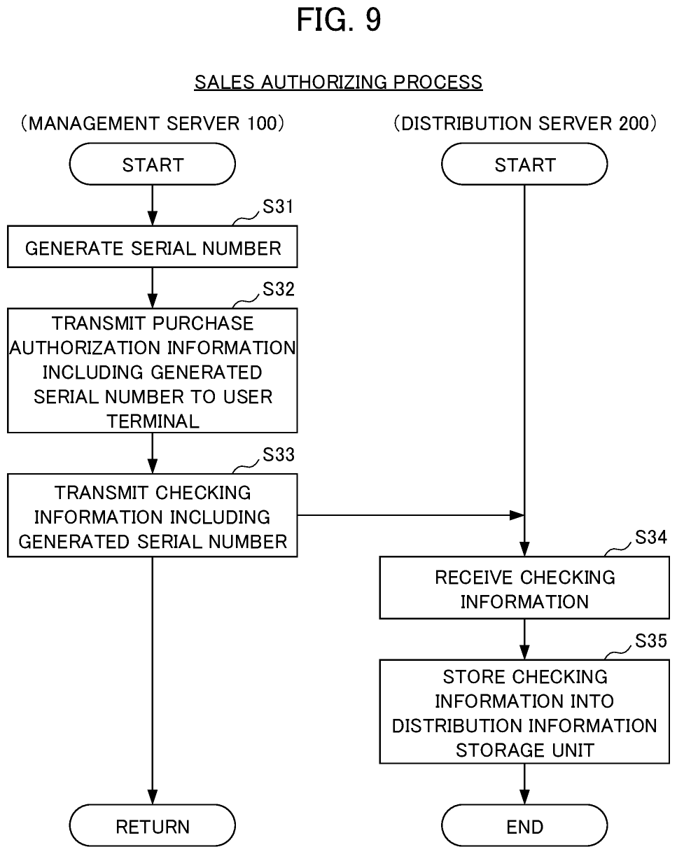

A flowchart in FIG. 9 showing a sales authorizing process in the sales management server system 10 will be described. next. In S31, the control unit 110 (sales authorization processing unit 113) of the management server 100 generates a serial number of the application for which purchase has been. authorized. In S32, the control unit 110 (sales authorization processing unit 113) transmits purchase authorization information including the generated. serial number to the user terminal 400.

In S33, the control unit 110 (sales authorization processing unit 113) transmits checking information including the generated serial number to the distribution server 200. The checking information includes an app ID, an edge server ID of a distribution destination edge server 500, etc. in addition to the serial number. Then, the control unit 110 finishes the present process. The control unit 110 may perform the process in S32 and the process in S33 at. the same time. Alternatively, the control unit 110 may perform the process in S32 after the process in S33.

In S34, the control unit 210 (checking information receiving unit 211) of the distribution server 200 receives the checking information transmitted from the management server 100 in S35, the control unit 210 (checking information receiving unit 211) stores the received checking information into the distribution information storage unit 221. Then, the control unit 210 finishes the present process.

### [Application Distributing Process]

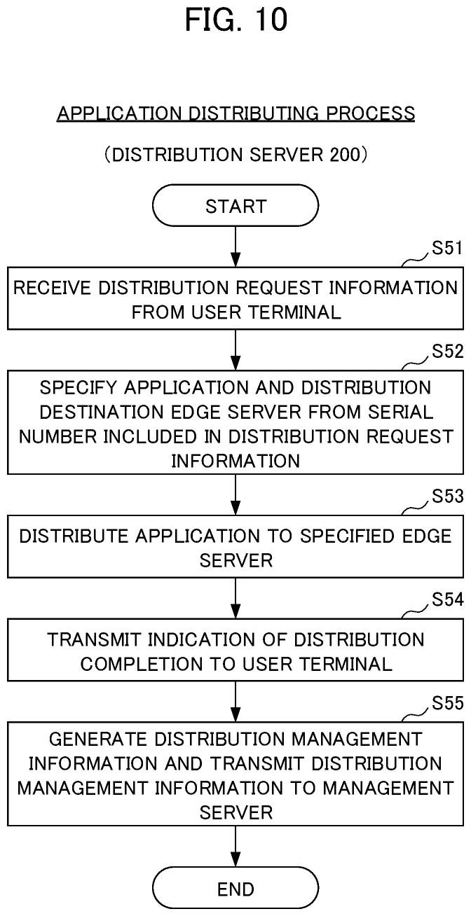

A process relating to application distribution will be described next on the basis of a flowchart in. FIG. 10 showing an application distributing process in the distribution server 200. As an example, a request to distribute the application is made by selecting application distribution on a menu screen not shown displayed on the user terminal 400. By inputting a serial number of the application to be distributed to the edge server 500 and selecting a transmission button on a screen for distribution (not shown) appearing in response to the selection of application distribution, the user terminal 400 transmits distribution request information to the distribution server 200. The distribution request information includes at least the serial number.

In S51, the control unit 210 (app distribution processing unit 212) of the distribution server 200 receives the distribution request information about the application from the user terminal 400. In S52, on the basis of the serial number in the distribution request information, the control unit 210 (app distribution. processing unit 212) refers to the distribution information storage unit 221 to specify the application and the edge server 500 to which the application is to be distributed.

In S53, the control unit 210 (app distribution processing unit 212) acquires the body of the specified application from the app DB 250, and distributes the acquired application to the specified edge server 500. In S54, in response to completion. of the distribution of the application to the edge server 500, the control unit 210 (app distribution processing unit 212) transmits an indication of the distribution completion. to the user terminal 400 having transmitted the distribution request information.

In S55, the control unit 210 (app distribution processing unit 212) generates distribution management information and transmits the generated distribution management information to the management server 100. Then, the control unit 210 finishes the present process. After the control unit 110 of the management server 100 receives the distribution management information from the distribution server 200, the control unit 110 updates the distribution management storage unit 123 on the basis of the received distribution management information.

As described above, in the application sales management system 1000, an application to run at the edge server 500 can be purchased and downloaded by a user from the sales management server system 10. For this purchase and downloading, information about the user having requested to purchase the application is transmitted to an app developer as a developer of the application requested to be purchased from the user, thereby allowing the app developer to judge whether to authorize selling of the application. This makes it possible to make the app developer take responsibility for selling of the application to the user.

Each device included in the application sales management system 1000 described above can be realized by hardware, software, or a combination thereof. Here, a device being realized by software means that a computer reads and executes a program (application) whereby the device is realized. The programs used in the present invention may be stored using various types of non-transitory computer-readable media and may be supplied to a computer. The non-transitory computer-readable media include various types of tangible storage media. Examples of the non-transitory computer-readable media include a magnetic recording medium. (for example, a flexible disk, magnetic tape, or a hard disk drive), a magneto-optical recording medium (for example, a magneto-optical disk) , a CD read only memory (CD-ROM), a CD-R, a CD-R/W, and a semiconductor memory (for example, a mask ROM, a programmable ROM (PROM), an erasable PROM (EPROM), a flash ROM, or a random access memory (RAM)). Moreover, the programs may be supplied to a computer in a form of various types of transitory computer-readable media. Examples of transitory computer-readable media include electrical signals, optical signals, and electromagnetic waves. The transitory computer-readable media can be used for supplying programs to a computer via wired communication paths such as electric wires and optical fibers, or wireless communication paths.

The above-described embodiment is a preferred embodiment of the present invention. However, the scope of the present invention is not limited to the embodiment only, but the present invention can be embodied in various modifications without departing from the spirit of the present invention.

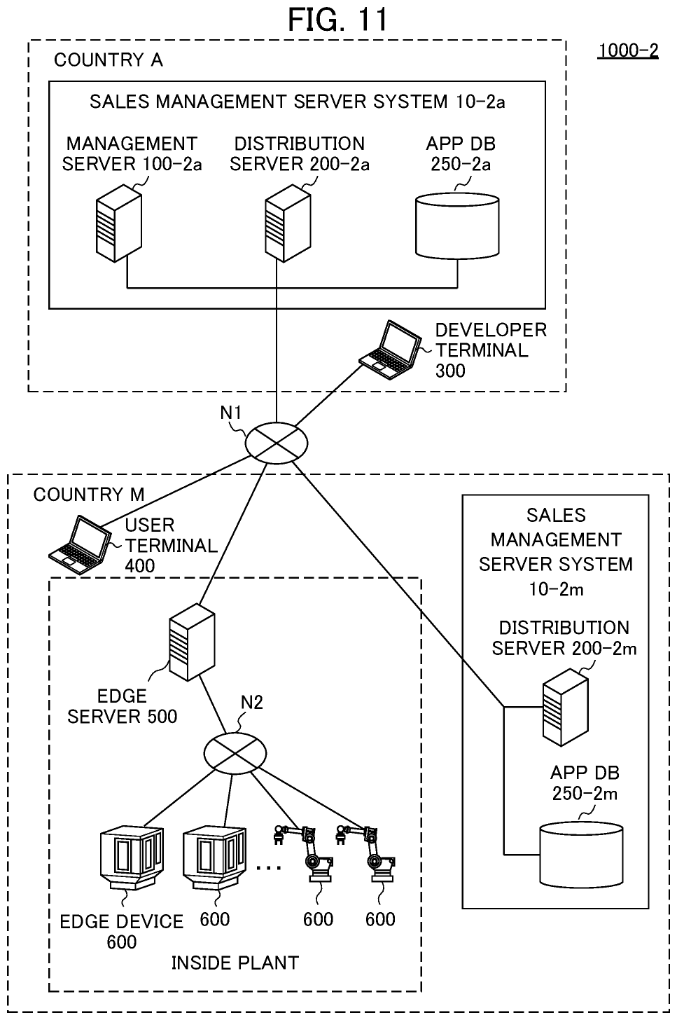

In the description of the foregoing embodiment, all the structures of the application sales management system are provided in one country. However, this is not the only case. The application sales management system is further applicable for use in a plurality of countries, for example FIG. 11 is a schematic view showing a basic configuration of an application sales management system 1000-2 according to a modified embodiment. The application sales management system 1000-2 includes a sales management server system 10-2a provided in a country A, and includes a sales management server system 10-2m in a country M different from the country A. Referring to the application sales management. system 1000-2, a management server 100-2a is provided in a country (region) of an operational administration company, for example, and a distribution server 200-2 (200-2a, 200-2m, etc.) and an app DB 250-2 (250-2a, 250-2m, etc.) are further provided in a country (country M) with the edge server 500. In this case, the app DB 250-2 (250-2a, 250-2m, etc.) may store the same app common to all the countries. Alternatively, the app DB 250-2a may be used as a main database storing all apps, and the app DB 250-2 (250-2m, etc.) in a corresponding country may be configured to store only an app authorized to be sold in. this country. While the developer terminal 300 belongs to the country A in this example, it may alternatively belong to the nationality of an app developer. In another case, there may be a plurality of developer terminals 300 in corresponding countries.

With the foregoing configuration of the application sales management system 1000-2, the user terminal 400 of a user in the country N transmits a purchase request to the management server 100-2a. If an app developer makes a judgment of being purchasable, the management. server 100-2a specifies the country M on the basis of purchase request information, and transmits purchase authorization information to the user terminal 400 including access information about access to the distribution server 200-2m. Then, the user terminal 400 transmits distribution. request information to the distribution server 200-2m, and the distribution server 200-2m transmits an application stored in the app DB 250-2m to the edge server 500. By doing so, the operational administration company applies control regulation regarding export only in storing the application into the app DIB 250-2m. In distributing the application to an intended edge server 500, the application can be distributed without any particular regulation.

In the embodiment described above, a serial number is used as distribution authorization information. or checking information. However, this is not the only example. The distribution authorization information or the checking information may be information for authorizing distribution of an application unthinkable to an outsider.

In the embodiment described above, various pieces of information are stored in the storage units 120 and 220 of the sales management server system 10. The pieces of information stored in these storage units are examples only, and other pieces of information may be included. Moreover, a data retention method is shown an example only.

As described above, the embodiment fulfills the following operations and effects, for example.

(1) The sales management server system 10 is for management of online store sale of an application to run at the edge server 500 communicably connected to one or more edge devices 600. The sales management server system 10 includes: the app DB 250 storing the application generated by a developer to be registered for online store sale; the management server 100 that manages online store sale for making the application available for purchase stored in the app DB 250 and registered for online store sale; and the distribution server 200 that distributes the application to the edge server 500. The sales management. server system 10 is communicably connected via the network N1 to the user terminal 400 of a user to use the edge device 600 and the edge server 500 and to the developer terminal 300 of the developer. The management server 100 includes the purchase request. processing unit 112 that transmits purchase request information to the developer terminal 300 of the developer of the application about the application for which a purchase request has been given from the user via the user terminal 400. If availability information received from. the developer terminal 300 responsive to the purchase request includes an indication of being purchasable, the purchase request processing unit 112 transmits purchase authorization information to the user terminal 400 including distribution authorization information for making correlation with. the application. If the availability information responsive to the purchase request includes an indication. of not being purchasable, the purchase request processing unit 112 transmits the indication of not being purchasable to the user terminal 400. The distribution server 200 includes the app distribution processing unit 212 that distributes the application corresponding to the distribution authorization information to the edge server 500 in response to receipt of distribution request information including the distribution authorization information transmitted from the user terminal 400. As a result, a mechanism can be formed for causing an app developer responsible for an application in terms of function, reliability, etc. to make a judgment as to availability responsive to a request to purchase the application in this way, responsibility for an application in terms of function, reliability, etc., can be taken by an appropriate side, not by an operational administration company of the system. If availability information responsive to a request to purchase an application includes an indication of being purchasable, distribution authorization information is provided to the user terminal 400 and the application corresponding to the distribution authorization information is distributed to the edge server 500. In this way, the application is distributed to the edge server 500 for only a user having made the purchase request.

(2) in the sales management server system 10 described in (1), the management server 100 may include the sales authorization processing unit 113. If the availability information received from the developer terminal 300 responsive to the purchase request includes an indication of being purchasable, the sales authorization processing unit 113 issues the distribution authorization information and checking information corresponding to the distribution authorization information, and transmits the issued checking information to the distribution server 200. If a match between the distribution authorization information included in the distribution request information and the checking information. is confirmed, the app distribution processing unit 212 of the distribution server 200 may distribute the application corresponding to the distribution authorization information to the edge server 500. This makes it possible to construct a mechanism of application distribution to be applied only if a match is confirmed between. the checking information corresponding to the distribution authorization information transmitted directly from the management server 100 to the distribution server 200 and the distribution authorization information included in the distribution request information transmitted from the user terminal 400. As a result, distribution of the application is authorized only if the distribution server 200 is a server authorized by the management server 100.

(3) In the sales management server system 10 described in (2), the sales authorization processing unit 113 and the purchase request processing unit 112 of the management server 100 may transmit the checking information and the purchase authorization information respectively at the same time. By doing so, at the time of transmission of the distribution. request information from the user terminal 400, the distribution server 200 can be placed in a state in which the checking information is received and stored as a target of the matching.

(4) In the sales management server system 10 described in (2) or (3), the distribution authorization information and the checking information may include the same information. This facilitates matching therebetween as the matching can be made on the basis of the same information.

(5) In the sales management server system 10 described in any one of (1) to (4), the purchase request information may include the name of the user, the address of the user including at least a region name, and the name of the application. By doing so, the purchase request information can be provided to the app developer as a basis for judging availability responsive to the request to purchase the application.

(6) The application sales management system 1000-2 including the sales management server system 10-2a described in any one of (1) to (5) includes the sales management server system 10-2m different from the sales management server system 10-2a. The sales management server system 10-2m includes the app DB 250-2m and the distribution server 200-2m, and is provided in one or more regions for which the developer authorizes selling. If the availability information received from the developer terminal 300 responsive to the purchase request includes an indication of being purchasable, the purchase request processing unit 112 of the management server 100 specifies the distribution server 200-2m of the one sales management. server system 10-2m on the basis of the purchase request information, and transmits the purchase authorization. information to the user terminal 400 including access information about access to the specified distribution server 200-2m. In this configuration, the user terminal 400 transmits the distribution request information to the distribution server 200-2m in a country to which the user belongs, and the application stored in the app DB 250-2m is transmitted to the edge server 500. This can eliminate a need for an operational administration company to take importing act in distributing the application to an intended edge server 500.

(7) The management server 100 is provided in the sales management server system 10 for management of online store sale of an application. to run at the edge server 500 communicably connected to one or more edge devices 600. The management server 100 manages online store sale for making the application available for purchase stored in the app DB 250 storing the application generated by a developer and registered for online store sale. The management server 100 is communicably connected via the network N1 to the user terminal 400 of a user to use the edge device 600 and the edge server 500 and to the developer terminal 300 of the developer. The management server 100 includes the purchase request processing unit 112 that transmits purchase request information to the developer terminal 300 of the developer of the application about the application for which a purchase request has been given from. the user via the user terminal 400. If availability information received from the developer terminal 300 responsive to the purchase request includes an indication of being purchasable, the purchase request processing unit 112 transmits purchase authorization information to the user terminal 400 including distribution authorization information for making correlation with the application. If the availability information responsive to the purchase request includes an indication of not being purchasable, the purchase request. processing unit 112 transmits the indication of not being purchasable to the user terminal 400. As a result, the effect of the management server 100 described in (1) can be achieved.

(8) The distribution server 200 is provided in the sales management server system 10 for management of online store sale of an application to run at the edge server 500 communicably connected to one or more edge devices 600. The distribution server 200 distributes the application generated by a developer and stored in the app DB 250 to the edge server 500. The distribution server 200 is communicably connected. via the network N1 to the user terminal 400 of a user to use the edge device 600 and the edge server 500 and to the developer terminal 300 of the developer. The distribution server 200 includes the app distribution processing unit 212. In response to receipt of distribution. request information from the user terminal 400 including distribution authorization information. for making correlation with the application and included in purchase authorization information transmitted to the user terminal 400 from the management server 100 that manages online store sale for making the application available for purchase stored in the app DB 250 and registered for online store sale, the app distribution processing unit 212 distributes the application corresponding to the distribution authorization information to the edge server 500. As a result, the effect of the distribution server 200 described in (1) can be achieved.

### EXPLANATION OF REFERENCE NUMERALS

1000, 1000-2 Application. sales management system
10, 10-2a, 10-2m Sales management server system
100, 100-2a Management server
110, 210 Control unit
111 Browsing information providing unit
112 Purchase request processing unit
113 Sales authorization processing unit
114 Distribution management processing unit
120, 220 Storage unit
121 App management information storage unit
122 User storage unit
123 Distribution management storage unit
124 App developer information storage unit
200, 200-2a, 200-2m Distribution server
211 Checking information receiving unit
212 App distribution processing unit
221 Distribution information. storage unit
250, 250-2a, 250-2m Application DB
300 Developer terminal
400 User terminal
500 Edge server
600 Edge device
N1, N2 Network

What is claimed is:

1. An application sales management server system for management of online store sale of an application to run at an edge server communicably connected to one or more edge devices, the application sales management server system comprising:
an app database storing the application generated by a developer to be registered for online store sale;
a management controller that manages online store sale for making the application available for purchase stored in the app database and registered for online store sale; and
a distribution controller that distributes the application to the edge server,
the application sales management server system being communicably connected. via a communication network to a user terminal of a user to use the edge device and the edge server and to a developer terminal of the developer,
the management controller comprising:
a purchase request transmitting unit that transmits purchase request information to the developer terminal of the developer of the application about the application for which a purchase request has been given from the user via the user terminal; and
a result transmitting unit, if availability information received from the developer terminal responsive to the purchase request includes an indication of being purchasable, the result transmitting unit transmitting purchase authorization information to the user terminal including distribution authorization information for making correlation with. the application, if the availability information responsive to the purchase request indicates an indication of not being purchasable, the result transmitting unit transmitting the indication of not being purchasable to the user terminal,
the distribution controller comprising an application distribution unit that distributes the application corresponding to the distribution authorization information to the edge server in response to receipt of distribution request information including the distribution authorization information transmitted from the user terminal.

2. The application sales management server system according to claim 1, wherein
the management controller comprises:
an issuing unit, if the availability information received. from the developer terminal responsive to the purchase request includes an indication of being purchasable, the issuing unit issuing the distribution authorization information and checking information corresponding to the distribution authorization information; and
a checking information transmitting unit that transmits the checking information issued by the issuing unit to the distribution controller, and
if a match between the distribution authorization information included in the distribution request information and. the checking information is confirmed, the application distribution unit of the distribution controller distributes the application corresponding to the distribution authorization information to the edge server.

3. The application sales management server system according to claim 2, wherein
the checking information transmitting unit and the result transmitting unit of the management controller transmit the checking information and the purchase authorization information respectively at the same time.

4. The application sales management server system according to claim 2, wherein
the distribution authorization information and the checking information include the same information.

5. The application sales management server system according to claim 1, wherein
the purchase request information includes the name of the user, the address of the user including at least a region name, and the name of the application.

6. An application sales management system with the application sales management server system according to claim 1, the application sales management system comprising:
an application sales management server system different from the application sales management server system, the different application sales management server system comprising the app database and the distribution controller, and provided in one or more regions for which the developer authorizes selling,
if the availability information received from the developer terminal responsive to the purchase request includes an indication of being purchasable, the result transmitting unit of the management controller specifying the distribution controller of the one application sales management server system on the basis of the purchase request information, and transmitting the purchase authorization information to the user terminal including access information about access to the specified distribution controller.

7. A management controller provided in an application sales management server system for management of online store sale of an application to run at an edge server communicably connected to one or more edge devices, the management controller managing online store sale for making the application available for purchase stored in an app database storing the application generated by a developer and registered for online store sale,
the management controller being communicably connected via a communication network to a user terminal of a user to use the edge device and the edge server and to a developer terminal of the developer, the management controller comprising:
a purchase request transmitting unit that transmits purchase request information to the developer terminal of the developer of the application about the application for which a purchase request has been given from the user via the user terminal; and
a result transmitting unit, if availability information received from the developer terminal responsive to the purchase request includes an indication of being purchasable, the result transmitting unit. transmitting purchase authorization information to the user terminal including distribution authorization information for making correlation with the application, if the availability information responsive to the purchase request includes an indication of not being purchasable, the result transmitting unit transmitting the indication of not being purchasable to the user terminal.

8. A distribution controller provided in an application sales management server system for management of online store sale of an application to run at an edge server communicably connected to one or more edge devices, the distribution controller distributing the application generated by a developer and stored in an app database to the edge server,
the distribution controller being communicably connected via a communication network to a user terminal of a user to use the edge device and the edge server and to a developer terminal of the developer,
the distribution controller comprising an application distribution unit, in response to receipt of distribution request information from the user terminal including distribution authorization information for making correlation with the application and included in purchase authorization information transmitted to the user terminal from a management controller that manages online store sale for making the application available for purchase stored in the app database and registered for online store sale, the application distribution unit distributing the application corresponding to the distribution authorization information to the edge server.
